(19) United States
(12) Patent Application Publication
(10) Pub. No.: US 2017/0147968 A1
(43) Pub. Date: May 25, 2017

(54) METHOD FOR EQUIPPING THE PACKAGING OF AN ARTICLE PACKAGED READY FOR SALE, APPARATUS FOR EXECUTING THE METHOD, AND INFORMATION CARRIER FOR SUCH A METHOD

(71) Applicant: WRH Walter Reist Holding AG, Ermatingen (CH)

(72) Inventor: Nick MYSICKA, Stafa (CH)

(73) Assignee: WRH Walter Reist Holding AG, Ermatingen (CH)

(21) Appl. No.: 15/346,300

(22) Filed: Nov. 8, 2016

(30) Foreign Application Priority Data
Nov. 23, 2015 (CH) 0170/15

(51) Int. Cl. G06Q 10/08; H04W 4/00; H04W 4/02; H04W 76/02

(52) U.S. Cl. CPC G06Q 10/087; H04W 76/023; H04W 4/008; H04W 4/02

(57) ABSTRACT

A method for equipping the packaging (11) of an article (10), packaged ready for sale, with additional information intended for the end buyer of the article, that includes: (a) providing the article (10) packaged ready for sale; (b) providing an information carrier (14) provided with the additional information; (c) determining a location on or at the packaging (11), at which the information carrier (14) is to be placed; (d) placing the information carrier (14) at the predetermined location on or at the packaging (11) of the article packaged (10) ready for sale, in such a manner that the information carrier (14) remains at this location; and (e) providing the article (10), provided with the information carrier (14), for further processing.

### CROSS-REFERENCE TO RELATED APPLICATIONS

Swiss Patent Application 01701/15, filed 23 Nov. 2015, Swiss, the priority document corresponding to this invention, to which a foreign priority benefit is claimed under Title 35, United States Code, Section 119, and their entire teachings are incorporated, by reference, into this specification.

### BACKGROUND OF THE INVENTION

Field of the Invention

The present invention relates to the field of the production and distribution of articles. It relates to a method for equipping articles with additional information intended for the end buyer.

It additionally relates to an apparatus for executing the method, and to an information carrier for such a method.

Discussion of Related Art

The equipping of articles with information intended for the end buyer (customer or consumer) of the article plays an important role in the distribution of the articles, in particular for marketing purposes. Frequently, such information is applied by printing the packaging on the articles. A further equipping possibility consists in applying such information to the articles by means of printed labels. Known from the prior art for this purpose are various methods and apparatuses, by means of which articles can be provided with labels.

EP1010630 A2 describes a bag laminate, which comprises an inner layer and an outer layer, containing a fixed part and a removable sticker part. The fixed part, having a permanent adhesive, is fixed to the inner layer. The removable sticker part is provided with an adhesive on one side, towards the inner layer, the adhesive fixing the removable sticker part to the inner layer in a non-permanent manner. Described, inter alia, is a pressure-sensitive adhesive, which remains on the removable sticker part when the removable sticker part is removed from the inner layer, such that the sticker can be applied to other articles such as, for example, children's clothing.

U.S. Pat. No. 8,065,827 B2 describes, inter alia, a bottle having a label that serves for advertising purposes. The label may provide information relating to the bottle, or information that is not related to the bottle. Also described is an information carrier, and a fixing element by which an advertising product can be applied to a container. The fixing element may be configured such that it allows the consumer to replace or re-apply the advertising product.

U.S. Pat. No. 8,272,562 B2 describes a swing tag for advertising purposes, having assorted product samples, combined with interactive, scannable codes that refer to contact information or URLs. The swing tag may provide advertising samples, or cross-advertising samples, and associated information, the swing tag carrying a scannable code such as, for example, a QR code, and an integrated product sample such as, for example, a fragrance sample. The swing tag may be attached to the article by a cord.

US2012/0031548 describes an apparatus for applying a label to a non-standard surface. The apparatus comprises a label feed element, an arrangement of label conformation pallets, a pressure source, and an arrangement of target-object presentation stations. The label feed element comprises a detaching tip, disposed adjacently to a carrier-film path, and a label path that, from the detaching tip onwards, goes in a direction differing from that of the carrier film path. The arrangement of label conformation pallets is constrained to orbit a pallet path. Each pallet comprises a tray, which forms a cavity that is associated with a previously defined shape of a non-standard surface, and which has an outer edge and has an elastic membrane that closes the cavity along the outer edge. The target-object presentation stations are designed such that they can hold individual target objects, and are constrained to orbit a target-object path, a part of the target-object path being disposed adjacently to the pallet path.

DE19832548 A1 describes a method and an apparatus for labelling dissimilar articles, wherein at least one sensor means identifies the, preferably geometric, properties of an article to be labelled, a preferred position on the article is determined in dependence on the properties, and a labelling is applied to the preferred position on the article by a labelling means.

In the equipping of articles with information, various factors play an important role in respect of the type of the article or the information to be applied. For example, in the case of equipping a series of articles with labels, it is desirable that the labels be applied at a predetermined location. In the case of a series of beverage bottles, the labels should each be disposed, for example, at the same level. Further requirements for the label are imposed by the specific shape of the article, or the condition of the surface on which the information is applied, or by the manner in which the label is applied to the articles, which may go beyond the equipping of smooth, flat surfaces. Apart from the equipping of the articles by the manufacturer themselves, it is furthermore occasionally the case that a third-party vendor applies their information, in addition to the information already present on the article concerned, in the context of a cross-marketing project. In such operations, precise positioning of the label on the article may be particularly important. In the context of special actions that accompany the usual distribution of the article, e.g. competition actions, it may additionally be a requirement that the label can be detached from the article and used further in a manner to be determined.

### SUMMARY OF THE INVENTION

It is therefore an object of the invention to provide a method for equipping articles with information that improves the flexibility of application. It is also an object of the invention to provide a method for equipping articles with information that can be executed independently of a process of producing the articles.

It is a further object of the invention to specify an apparatus for executing the method, and an information carrier for the method.

The objects are achieved by the features of the subject claims. Exemplary and/or preferred embodiments of the invention are given in the dependent claims and in the present disclosure.

The method according to the invention for equipping the packaging of an article, packaged ready for sale, with additional information intended for the end buyer of the article comprises the steps: (a) providing the article packaged ready for sale; (b) providing an information carrier provided with the additional information; (c) determining a location on or at the packaging, on which the information carrier is to be placed; (d) placing the information carrier at the predetermined location on or at the packaging of the article packaged ready for sale, in such a manner that the information carrier remains at this location; and (e) providing the article, provided with the information carrier, for further processing.

The method according to the invention is suitable, advantageously, for equipping the packaging of an article with individual information carriers, but it is also conceivable to equip the packaging of an article with a plurality of information carriers.

The providing and placing of the information carrier, having additional information, offers the advantage that information already present on the packaging of the article can be supplemented or replaced. This may prove useful, for example, in the case of cross-marketing projects, in which the additional information may differ from the information already present in respect of the appearance, e.g. the labelling of the article. Furthermore, this additional information offers the advantage that the advertising area of the packaging that carries the already present information can be supplemented and, if desired, expanded.

Advantageously, following placing, the information carrier can be detached again, which can be done, for example, by an end buyer, who can use the information carrier for a different purpose, e.g. for a competition action. In a particularly advantageous embodiment, the information carrier, after having been detached, can be repositioned back on the article or at a different location.

For the purpose of coordinating with the basic information, the information carrier having the additional information may be, for example, at least partly transparent. This can be advantageous if the additional information covers basic information that must remain visible for legal reasons, such as, for example, particular foodstuffs information.

According to an embodiment of the invention, there is already basic information for the end buyer of the article placed on the packaging of the article packaged ready for sale, and the location for the additional information is determined, according to the placing of the basic information, in step (c) of determining a location on or at the packaging at which the information carrier is to be placed.

Depending on the application, which may depend, for example, on the respective (cross-) marketing strategy or on respective actions, such as competitions or time-limited special offers, the placing of the additional information may be effected in a variety of ways. The determining of the location for the additional information, according to the placing of the basic information, may be important, in particular, for cross-marketing projects, in which the additional information is advantageously intended to supplement the basic information and to coordinate with the latter.

In particular, the basic information may be at least partly covered by the application of the additional information.

This may be used, advantageously, to cover basic information such that it becomes visible when the information carrier is detached from the article. Particular advertising information may be placed in this way, such that an end buyer, by detaching the information carrier, becomes involved in the imparting of the advertising message.

Alternatively or additionally, the additional information together with the basic information may constitute an information unit.

For example, the basic information may be a first part of an image, and the additional information a second part of the image, the basic information and the additional information complementing one another to form the complete image.

Alternatively, the additional information may be applied entirely separately from the basic information.

As a result, the additional area for the information applied on the article, which would otherwise remain unused, is utilized.

In another embodiment of the method according to the invention, before the step (d) of placing the information carrier at the predetermined location on or at the packaging of the article packaged ready for sale, in such a manner that the information carrier remains at this location, for this step the article packaged ready for sale is positioned in its spatial position with respect to this step.

This may be advantageous, for example, if the suitable positioning of the package article can be achieved more favorably than a suitable positioning of the information carrier for the placing of the information carrier at the predetermined location.

In particular, before the article packaged ready for sale is positioned, the type and/or current position of the article can be sensed, and the result of this sensing can be used to control one or more of the subsequent method steps.

The control of one or more method steps in dependence on the result of the sensing of the type and/or the current position of the article offers the advantage that the automation of the method can be increased.

The control of one or more method steps may be a typological control, the typology normally relating to the type of articles in a series.

Alternatively or additionally, the control may be an individually specified control, wherein the individual specification may relate, for example, to an individual product. An individual specification and suitable control is also conceivable with regard to the end buyer, such that a product may be matched to the individual end buyer by the individualized, additional information.

An individually specified control may advantageously feed back into one of the method steps according to the invention, in dependence on the result of a sensing of the article, such that an individual closed-loop control circuit is created.

In an advantageous embodiment, a local or remote database may be provided, from which, for the purpose of control, a control module or a data processing device obtains typological or individual data, e.g. relating to the end buyer, and uses this data for the individually specified control.

Optionally, before the article packaged ready for sale is positioned, the spatial shape of the article is sensed, and the result of this sensing is used to control one or more of the subsequent method steps.

This may be advantageous, in particular, in the case of articles or packagings that have uneven surfaces. If necessary, the result of the sensing of the spatial shape of the article and/or of the packaging of the article can be used, for example, to adapt the placing of the information carrier, such that, after having been placed, the information carrier can remain at the predetermined location, even in the case of uneven surfaces.

Optionally, the type and/or the spatial position of the basic information may be sensed, and the placing of the additional information matched to this sensing. This may be advantageous, for example, if a part of the basic information is not to be covered.

In another embodiment of the method according to the invention, the article packaged ready for sale is produced in a production process, and the step of providing the article packaged ready for sale follows the production process.

In a further embodiment of the method according to the invention, the article packaged ready for sale is in packs and, in the step of providing the article packaged ready for sale, the article packaged ready for sale is singled for further processing.

This may occur, for example, if, in the context of a cross-marketing project, the equipping of the article with the additional information is performed, not by the manufacturer themselves, but by the distributor or a third-party vendor. In particular, in the step of providing the article, provided with the information carrier, for further processing, a multiplicity of articles packaged ready for sale and provided with the information carrier nay be grouped together to form a pack.

In this way, the articles can be delivered to a distributor after they have been equipped with information.

In yet another embodiment of the method according to the invention, externally supplied control information is used for providing the information carriers provided with the additional information.

This has the advantage that the automation of the method can be increased. Further, the control information can be coupled with results of a sensing of the type and/or shape and/or current position of the article, so as to form a closed-loop control circuit, by means of which the equipping of the articles with information can be controlled.

In a further embodiment of the method according to the invention, the externally supplied control information is suitable for individualizing the information carriers provided with the additional information.

This has the advantage that the flexibility of the method can be increased, since the information carrier can be individualized according to the type and design of the article and, if necessary, customized for an already known end buyer and adapted to the respective article. Optionally, it is also possible to equip a series of like articles with differing, individualized information carriers.

The method according to the invention offers the particular advantage that the equipping of the article with additional information is not coupled to the production process, and can be performed independently of the process of producing the articles. Any peculiarities of the article and of the location, to be determined, at which the information carrier is to be placed, can be sensed, and the result of the sensing can be used for the subsequent method steps, ensuring flexibility in respect of the article and independence from the production process.

Furthermore, the externally supplied control information for individualizing the information carriers provided with the additional information may be supplied from an external databases, via a network.

The apparatus according to the invention for executing the method according to the invention is characterized in that the apparatus comprises a controllable application device, and a controller that controls the operation of the controllable application device.

The controller in this case may be designed for the inputting of external control information.

In particular, the controller may be connected to external databases via a network.

Furthermore, the controller may be connected to means for sensing the type and/or current position and/or spatial shape of the article.

As an alternative to this, the controllable application device may also be connected to means for sensing the type and/or current position and/or spatial shape of the article.

Furthermore, there may be means for providing the information carriers, the means for providing the information carriers being connected to the controller and to the controllable application device.

It is also conceivable for the controllable application device to comprise first means for taking the article past second means for applying the information carriers.

The information carrier according to the invention for equipping the packaging of an article, packaged ready for sale, with additional information intended for the end buyer of the article, in the method according to the invention, is characterized in that the information carrier can be detached without residue from the article.

In particular, the detached information carrier can be repositioned on the packaging of the same article or at a different location.

This may be used, for example, for particular advertising or competition actions, in which the detached information carrier is repositioned on the packaging of another article, and the end buyer redeems a particular action with this packaging. Repositioning on the same article may be advantageous if the end buyer intends to attach the information carrier to the respective article, but possibly at a different location, for further use, after having detached the information carrier from the article, e.g. to examine the basic information.

The repositioning capability may be achieved, for example, by means of a suitable bonding agent, in particular an adhesive or adhesive surface. The bonding agent may optionally be pressure-sensitive. The bonding agent may be applied with full-surface or punctiform contact to the information carrier.

The information carrier may contain the additional information in a great variety of forms. This may be image and/or text elements or codes that can be sensed optically, or information that can be read out magnetically or electronically

In an embodiment of the invention, the information carrier is provided with electronic means for storing and/or transmitting the information.

In particular, the information carrier may comprise an NFC device.

For example, the information carrier may comprise an RFID tag. Preferably, the RFID tag is designed for near-field communication in the NFC standard, having a range of max. 10 cm, and differs, for example, from RFID tags for securing articles in the case of theft.

In particular, the information carrier may be repositioned on an NFC-enabled smartphone, in such a manner that the NFC device of the information carrier can establish near-field communication with the smartphone.

For example, the information carrier may be an RFID tag that is provided with a suitable adhesive or comparable bonding agents, and that can be repositioned on the back side of a smartphone. With the repositioned RFID tag, the smartphone can be used, for example, to redeem a particular action that is prescribed by the information carrier and, optionally, that is visible in the applied information. For example, a particular discount specified in the applied information may be redeemed in a cashless payment operation by means of the smartphone carrying the repositioned RFID tag.

In an embodiment, the information carrier comprises data for determining a utilization number, preferably a serial number, of the information carrier.

The utilization number may be used, for example, to measure a return rate or redemption rate of a particular voucher action or competition action. This information may be of use to the distributor and/or the advertiser for determining the success of the voucher action or competition action. For example, it is conceivable that, upon each redemption of a voucher, the serial number of the information carrier is read out by an NFC reader, and the read-out data are transmitted to a database that provides these data for determining the redemption rate or return rate.

### BRIEF DESCRIPTION OF THE DRAWINGS

The invention is to be explained in greater detail in the following on the basis of exemplary embodiments, in conjunction with the drawing. There are shown in:

FIG. 1 is a schematic side view of an exemplary article (liquid) provided with an information carrier, in a packaging in the form of a bottle;

FIG. 2 is a schematic diagram of the basic method steps, in an exemplary embodiment of the method according to the invention;

FIG. 3 is a schematic diagram of the basic method steps, in another exemplary embodiment of the method according to the invention;

FIG. 4 is a further exemplary embodiment of the method according to the invention, in which the steps according to FIG. 2 or 3 are performed directly following the production of the article;

FIG. 5 is a further exemplary embodiment of the method according to the invention, in which the steps according to FIG. 2 or 3 are performed independently of the production of the article;

FIG. 6 is a schematic representation of a possible positioning of the information carrier relative to the basic information, the basic information being completely covered;

FIG. 7 is a schematic representation of another possible positioning of the information carrier relative to the basic information, the information carrier forming a unit with the basic information and being detachable;

FIG. 8 is a schematic representation of a further possible positioning of the information carrier relative to the basic information, the information carrier being applied entirely separately from basic information;

FIG. 9 is a top view of an exemplary embodiment of an information carrier, which comprises an NFC device and which is repositionable;

FIG. 10 is a schematic, perspective view of a smartphone, with the information carrier from FIG. 9 repositioned on the back side thereof for wireless interaction with the smartphone;

FIG. 11 is a schematic side view of an exemplary embodiment of a controllable positioning device that can be used in the context of the invention, and of an adaptive application device acting in combination therewith;

FIG. 12 is a schematic side view of an application device that can be used in the context of the invention;

FIG. 13 is a sectional view of the application device from FIG. 12, along the section line A-A in FIG. 12;

FIG. 14 is a schematic representation of an application system, according to an exemplary embodiment of the invention, that is integrated into communication with external databases and that is suitable, in particular, for online commerce; and

FIG. 15 is a possible internal structure of the controller from FIG. 14.

### DESCRIPTION OF PREFERRED EMBODIMENTS

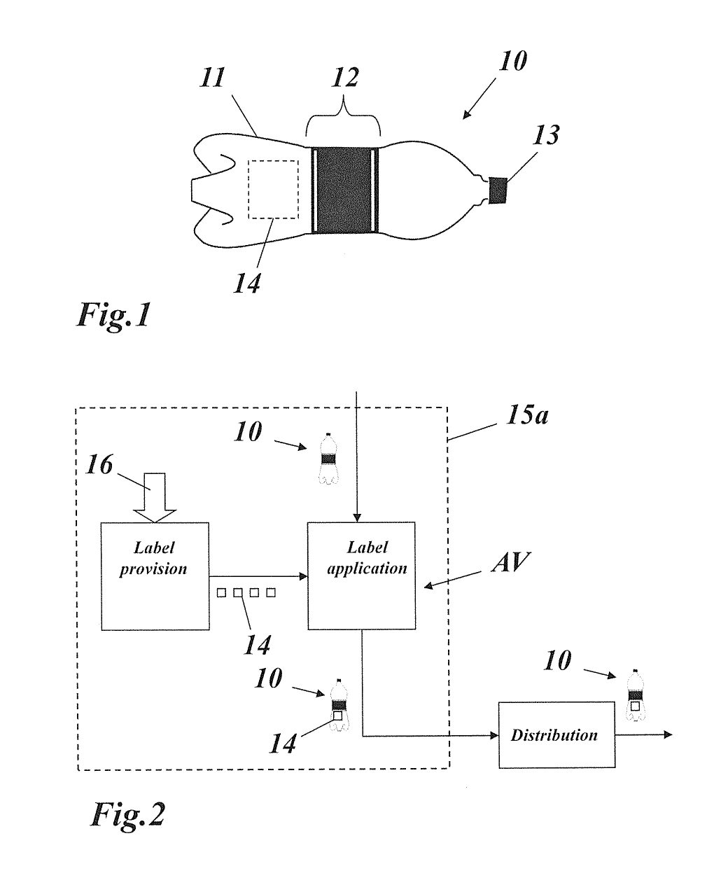

FIG. 1 shows a side view of an article (liquid, beverage) 10, provided with additional information on an information carrier 14, that comprises a packaging 11 in the form of a bottle 11. The bottle 11 is shown in a lying position, such that the base of the bottle 11 is located at the side. The bottle 11 comprises a closure 13, and basic information 12, applied to the outside of the bottle, which may comprise, for example, legally prescribed particulars such as composition, company of origin, etc. The basic information 12 may be printed on, for example, or be in the form of an adhesive-bonded sticker or label.

In the embodiment shown, the information carrier 14 is designed in the form of a label 14 that is applied to the bottle 11, in the lower region of the bottle 11 (towards the base), separately from the basic information 12, which is, for example, likewise realized as a label. The bottle 11 may be made, for example, of glass or PET. The surface in the lower region of the bottle 11, on which the label 14 is applied, is normally a curved surface, and the surface may have various uneven portions such as, for example, circumferential flutes, that are not shown in FIG. 1.

In one embodiment of the information carrier 14, the information carrier 14 may be used to cover such uneven portions or irregularities of the surface of the packaging 11.

The information carrier 14 may be, for example, a label having an imprint (optical information), contain a sample of an article (e.g. a perfume sample), or be a packaging having a sample, etc. The information carrier 14 (independent of the legal prescriptions) offers the advantage that it may be detachable, repositionable and coordinated with basic information already present on the article. For this purpose, in particular embodiments, the information carrier 14 may be at least partly transparent, such that basic information 12 or a portion of the basic information 12 can still remain visible, despite being covered by the information carrier 14.

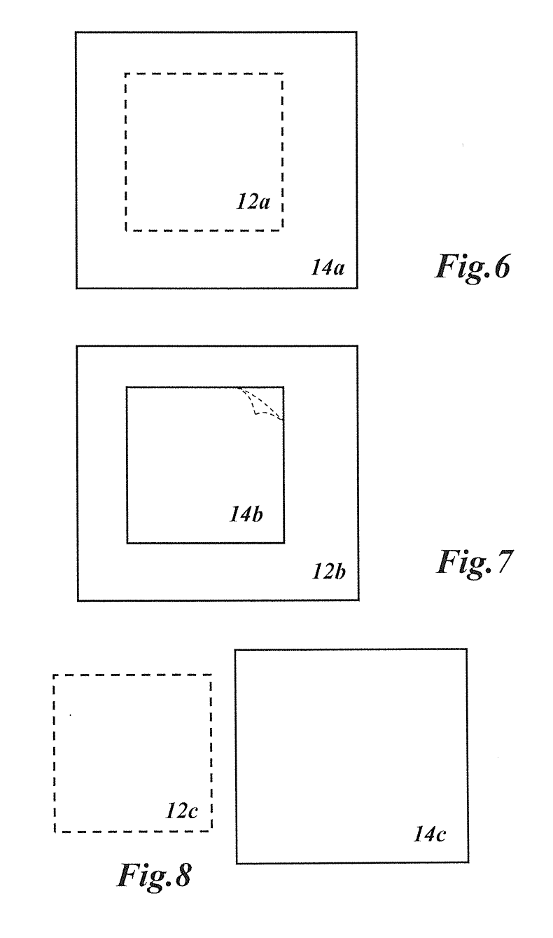

In the embodiment shown in FIG. 1, the label 14 is applied separately from the basic information 12, at a different location on the bottle 11 (see FIG. 8). If necessary, however, the label 14 may also be applied on the label 12 having the basic information 12, such that the basic information 12 is at least partly covered by the label 14 (see FIG. 6). In a variant, the label 14 may be applied to the label 12 having the basic information 12 in such a manner that the information on the label 14 forms a unit with the basic information 12, or is an integral constituent part of the basic information 12 (see FIG. 7).

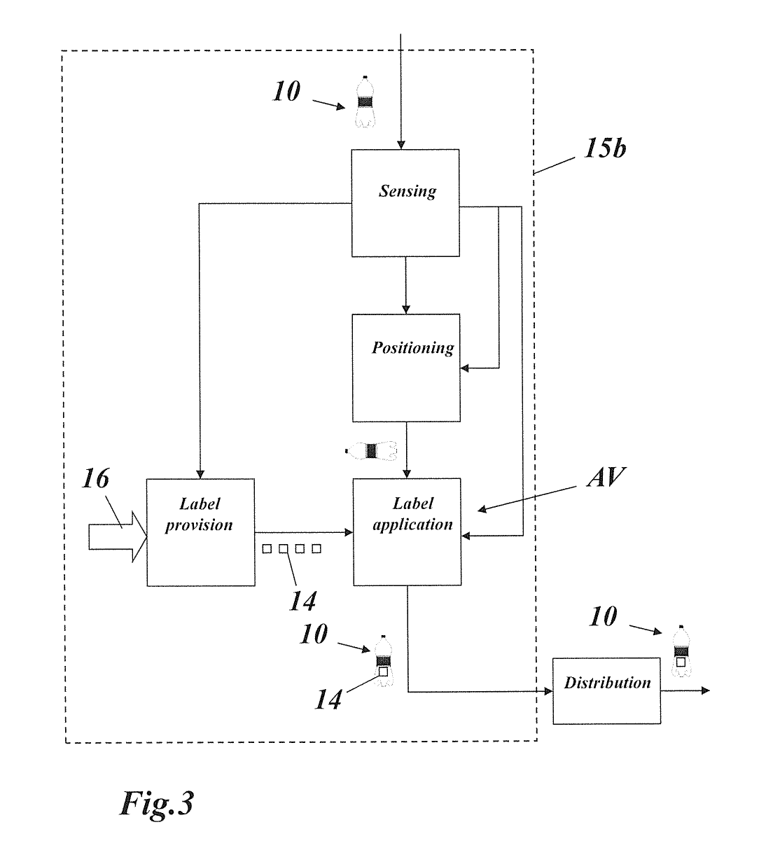

FIG. 2 shows a schematic diagram of the method steps of an application process 15a according to an embodiment of the method according to the invention. A distribution step is shown following the application process 15a. The shown application process 15a begins with the provision of an article 10, which is shown in the figure as a bottle from FIG. 1. One step of the method is constituted by providing information carriers, or labels 14, with additional information. If necessary, the provision of the labels 14, in particular also the design and information content thereof, may be controlled by externally provided control information 16. The control information 16 may alter, for example, the size, quality or imprint of the labels. In a further step of the method, the labels 14 are applied to the packagings of the articles 10 by means of an application device AV. Before the label 14 is applied, the location on or at the packaging of the article 10, at which the label 14 is to be placed, can be determined. The articles 10 provided with the label 14 are supplied to the distribution section and, via the distribution section, reach an end buyer, for whom the additional information is intended.

FIG. 3 shows a schematic diagram of the method steps in an application process 15b of a further embodiment of the method according to the invention, expanded in comparison with that of FIG. 2. The shown application process 15b begins with the provision of the articles 10, packaged ready for sale, again shown as a bottle in the figure. The article 10 is sensed in the sensing step.

In the sensing step, the type of the article 10, for example, may be sensed. The type of the article 10 to be sensed may comprise various properties of the article 10, or the packaging of the article 10, such as, for example, the material, the surface quality, the structure or the firmness, or other parameters.

Alternatively or additionally, the current position of the article 10 may be sensed.

Alternatively or additionally, the spatial shape and design of the article 10 may be sensed.

Alternatively or additionally, the type and/or the position of the basic information, relative to the article 10, may be sensed.

The result of the sensing may advantageously be used to control the subsequent steps of the method, this being illustrated in FIG. 3 by angled arrows between the steps “sensing”, “positioning”, “label application” and “label provision”. For example, the result of the sensing of the current position of the article 10 may be used for a step of positioning the article 10. On the basis of the sensed current position of the article 10, the article 10 may be spatially positioned such that the predefined location, at which a label 14 is to be applied, is oriented in an appropriate manner for the application of the label 14.

Alternatively or additionally, the result of the sensing may be supplied to the step of providing labels 14. The provision of the labels 14, in turn, may be controlled by external control information 16. Advantageously, the control information 16 may be altered in dependence on the result of the sensing. For example, depending on the result of the sensing of the type of the article 10, in the provision of the labels 14, differing labels 14, suitable for the respective article 10, may be selected from a label magazine (not shown in the figure), or the creation of the labels 14 may be individually matched to the type of the article.

Alternatively or additionally, the result of the sensing may be supplied to the step of applying the label 14. The application of the label 14 may be adapted according to the result of the sensing. For example, depending on the type of the article 10, e.g. depending on the material of the packaging, the pressure may be adjusted in the application of the label 14, such that the packaging does not become damaged, or deformed in an unwanted manner, during application. This is important, for example, if the article is packaged in flexible bags. Also conceivable, optionally, is the use of a suitable counter-pressure means such as, for example, a pressure contact surface, a mandrel or the supply of compressed air, that compensates the pressure in the application of the label 14.

The sensing of the spatial shape of the article 10 may be advantageous if the article 10, or the predefined location at which the label 14 is to be applied, has uneven surfaces or deviations from a standard surface. Depending on the result of the sensing, the application of the labels and/or the positioning may be adapted such that the label 14 can be applied to the article 10 in an appropriate manner.

The use of the result of the sensing for subsequent steps of the method may be advantageous if the additional information of the label 14 is to assume a spatially predefined position with respect to basic information already present on the article 10, which may be the case, for example, in cross-marketing projects. If the application of the label 14 is to be performed by a distribution partner or as part of the logistics process, independently of the manufacturer of the articles 10, the step of sensing may serve to adapt the subsequent steps to the respective article 10, thereby increasing the flexibility of the method.

Following the application of the label 14, the article 10 provided with a label 14 may be supplied to the distribution section, as shown in FIG. 3.

Following the application process 15a, b, an inspection step, for example combined with optical recognition, for checking the correct application of the additional information on the article 10, may optionally be effected before the article 10 reaches the distribution section. In the case of an incorrect application, the article concerned may be separated out, if necessary.

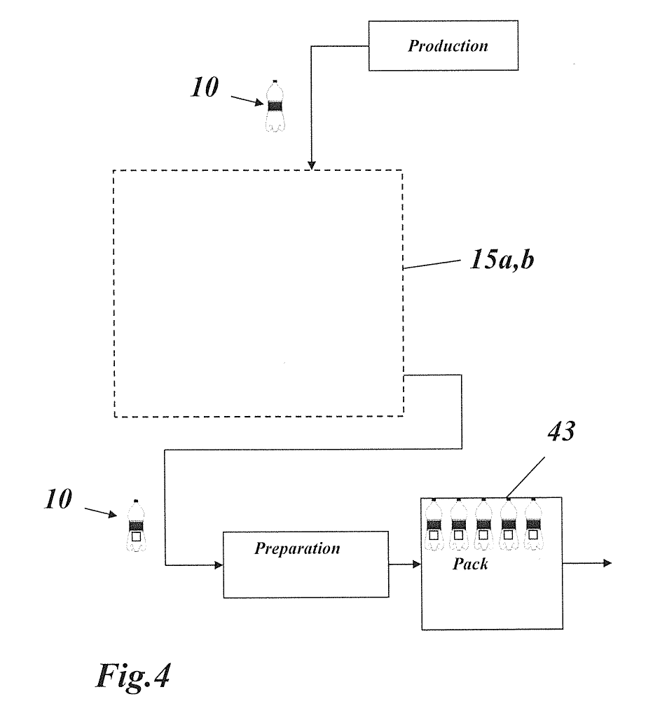

FIG. 4 shows a schematic diagram of an embodiment of the method according to the invention in which the article, packaged ready for sale, is produced in a production process. The application process 15a, b according to FIG. 2 or 3 directly follows the production of the article 10. Following the application process 15a, b, a multiplicity of articles 10 packaged ready for sale, provided with information carriers, are prepared and grouped together to form a pack 43. The pack 43 may finally be supplied to the distribution section. A pack in this case, as is usual, is understood to mean a commodity unit and a loading unit for distribution of articles. The pack represents the grouping together of products of the same type or differing types for collective ordering in commerce or for collective handling in logistics.

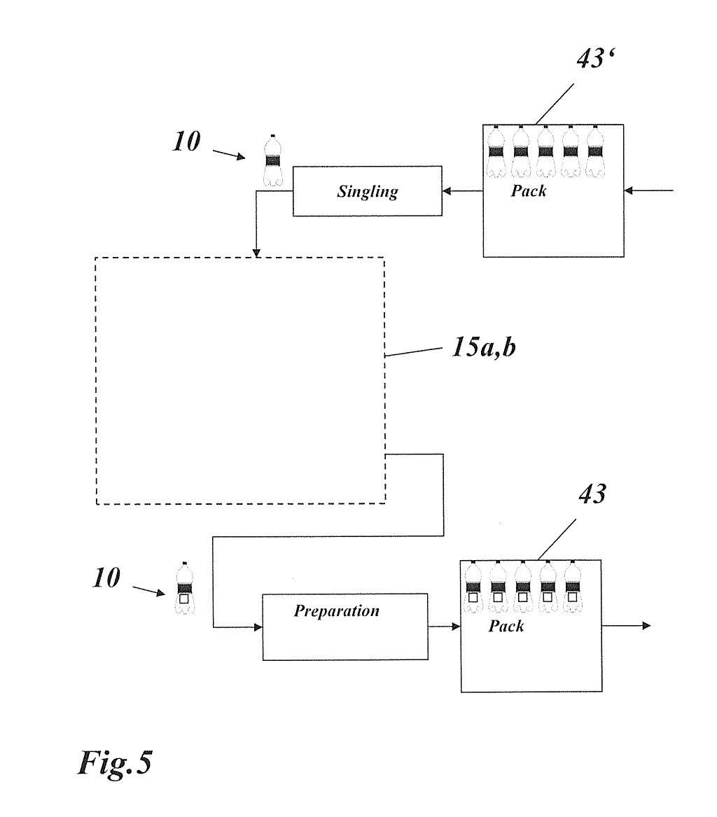

FIG. 5 shows a schematic diagram of a further embodiment of the method according to the invention, in which the articles 10, packaged ready for sale, are in a pack 43′, and are first singled for further processing. The singling step is followed by the application process 15a, b according to FIG. 2 or 3. Following the application process 15a, b, a multiplicity of articles 10, packaged ready for sale and provided with information carriers, are prepared and grouped together to form a pack 43. The pack 43 may finally be supplied to the distribution section. This embodiment of the method may pertain, for example, if the equipping of the articles 10 with information carriers is not performed by the manufacturer of the articles 10, but by a third-party producer or a distribution partner, which may be the case, for example, in cross-marketing projects. The application process 15a, b, which may apply additional information in a flexible manner to provided articles 10 of differing types, is particularly advantageous for this embodiment of the method.

FIG. 6 shows a schematic frontal view of an embodiment of an information carrier 14a that covers basic information 12a, in the form of a sticker or the like. The information carrier 14a is advantageously of a detachable design, such that an end buyer can detach the information carrier 14a, e.g. in the form of a sticker or label, from the packaging, revealing the basic information 12a. Such a design of the information carrier 14a may be advantageous, for example, in the case of competition actions or prize-draw actions, in which the basic information 12a includes, for example, a competition code, which is covered by the information carrier 14a.

FIG. 7 shows a schematic frontal view of a further embodiment of an information carrier 14b that forms a unit, or integral constituent part, with basic information 12b, in the form of a sticker and that is detachable. The detachability is indicated by a broken-line portion of a detached corner of the information carrier 14b. The information carrier 14b, e.g. in the form of a sticker, may also be designed so as to partly overlap the basic information 12b. Alternatively, the information carrier 14b may be arranged adjacently to the basic information 12b.

FIG. 8 shows a schematic frontal view of a further embodiment of an information carrier 14c that is applied entirely separately from basic information 12c, at a separate location.

The information carrier 14a, b, c is advantageously designed so as to adhere in a repositionable manner, such that, after having been detached, without residue, from the article, it can be applied to a different location on the same article. For this purpose, the information carrier 14a, b, c may be provided with a bonding agent, e.g. a peeling glue. The information carrier 14a, b, c may also be designed so as to be repositionable in such a manner that it can be applied to a different article. This may be advantageous, for example, for particular voucher actions, e.g. if the end buyer can detach the information carrier 14a, b, c from an article and apply it to a different article, and can redeem the other article, with the repositioned information carrier 14a, b, c, for a particular action at a point of sale.

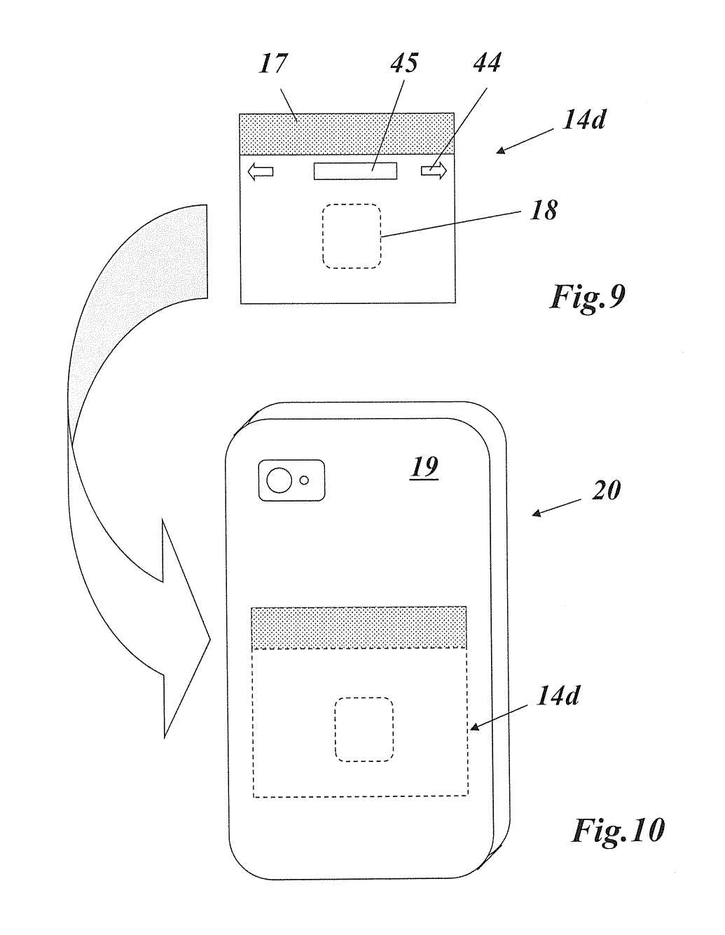

FIG. 9 shows a schematic frontal view of a further embodiment of an information carrier 14d, which comprises an NFC device 18 and which is repositionable. The information carrier 14d comprises an adhesive strip 17, by means of which the information carrier 14d can be applied to an article (not shown). If necessary, however, the information carrier 14d can also be provided with a bonding agent over an entire surface, e.g. the back side of the information carrier 14d. The NFC device may be designed, for example, in the form of a (passive) RFID tag. Such an embodiment of an information carrier 14d may be advantageous if the additional information is to exceed visible, e.g. printed, information. An advantage of this embodiment is that it provides for differing possibilities for interaction by the consumer. Owing to the NFC device, the information carrier 14d can be provided with further functionalities, exceeding the mere display of visual information.

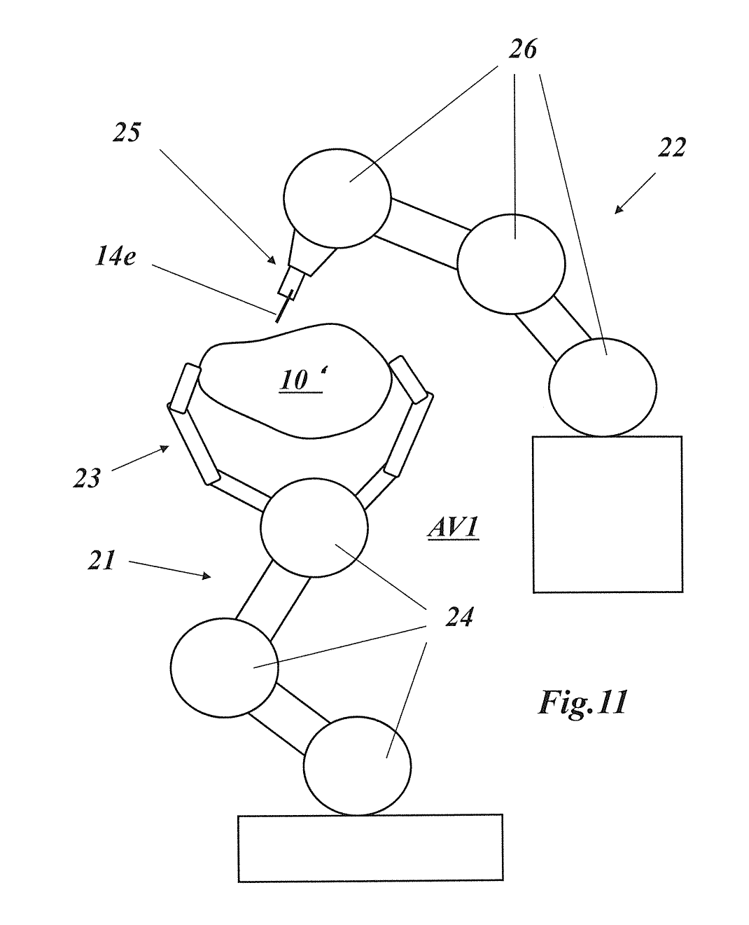

FIG. 10 shows a schematic, perspective view of an NFC-enable smartphone 20, with the information carrier 14d from FIG. 9 repositioned on the back side thereof. As an example, the information carrier 14d may originally have been disposed on a beverage bottle, and repositioned by the end buyer onto an NFC-enable smartphone. With the repositioned information carrier 14d, the smartphone may be used, for example, to redeem a particular action that is prescribed by the information carrier 14d and optionally contained in the applied information. For example, a particular discount, specified in the applied information, may be redeemed in a cashless payment operation by means of the smartphone 20, which carries the repositioned RFID tag. As part of an advertising action, a voucher may also be able to be transmitted from the information carrier 14d to the smartphone, which can be used in the manner of a pre-paid card or directly for a payment operation with the smartphone 20.

In a particularly preferred embodiment, the information carrier 14d comprises repositioning information 44, to enable the information carrier 14d to be aligned precisely when being repositioned. The repositioning information 44 may be a scale, a positioning cross, an arrow symbol 44 or similar, preferably, visible, information. The repositioning information 44 is preferably disposed on the front face of the information carrier 14d.

In a variant, the repositioning information 44 may also be disposed on the back face of the information carrier. This may be preferred for particular applications, e.g. if the entire front face is printed and there is no more space available for applying the repositioning information.

The repositioning information 44 may be particularly advantageous for an information carrier 14d having an NFC device. By means of the repositioning information 44, the information carrier 14d having the NFC device can be aligned precisely to a location for repositioning on an NFC read device such as, for example, a smartphone 20. The repositioning information 44 may also have particulars 45 relating to differing smartphone models. This may be advantageous because the NFC read devices for differing smartphone models are disposed at differing locations on the smartphone 20. A precise alignment of the information carrier 14d having the NFC device can thus render possible reliable near-field communication between the information carrier 14d and the NFC read device.

Corresponding repositioning information may be provided for other application cases, in which the information carriers have analog information, e.g. printed information, and are read by the human eye. This may be useful, for example, for information carriers that can be collected as collection stamps or collection vouchers by the consumer, and that can be repositioned on a collection unit, e.g. a collection card.

FIG. 11 shows a schematic side view of an embodiment of a controllable positioning device 21, and of an adaptive application device 22, which together form a highly flexible application device AV1 that can be used in a method according to the invention when there is a requirement for increased flexibility, this being necessary, for example, in the application of information carriers on continuously changing articles. The controllable positioning device 21 comprises gripping arms 23, which serve to hold an article 10′ of irregular form. Furthermore, the controllable positioning device 21 has a plurality of joints 24 that allow any three-dimensional spatial movement of the controllable positioning device 21. The controllable positioning device 21 may be controlled with a control information. If necessary, the control information may be coupled to the result of a sensing of the article 10′. The controllable positioning device 21 can hold and position the article 10′ in such a manner that the article 10′ is aligned in an appropriate manner for the application of an information carrier. Advantageously, the article 10′ is aligned in an appropriate manner with respect to the adaptive application device 22. The adaptive application device 22 comprises a holding device 25 and joints 26. The holding device 25, for example equipped with a suction cup or gripper, can hold an information carrier 14e and release it following the application operation. The adaptive application device 22 can be moved spatially in three dimensions by means of the joints 26. A suitable movement of the adaptive application device 22 enables the holding device 25, for example, to grip an information carrier 14e from a label magazine (not shown in the figure) and bring it to the article 10′. As the result of an appropriate movement and the application of an appropriate pressure, the adaptive application device 22 can apply the information carrier 14e at a predefined location on the article 10′. The adaptive application device 22 in this case may be controlled by a control information, the control information being able to be coupled, if necessary, to the result of a sensing of the article 10′. The control information may control, for example, the pressure of application or the instant at which the information carrier 14e is detached from the holding device 25.

In FIG. 11, the adaptive application device 22 is shown with three joints 26 and one holding device 25. It is also conceivable, however, for the adaptive application device 22 to have more joints and, in particular, a plurality of holding devices 25 that can be moved independently of one another, such that, for example, depending on the application, a plurality of and/or differing information carriers can be applied to a plurality of and/or differing articles. It is likewise conceivable for the controllable positioning device 21 to have a plurality of joints and more than the two gripping arms shown in FIG. 11, such that a plurality of articles can be held independently of one another.

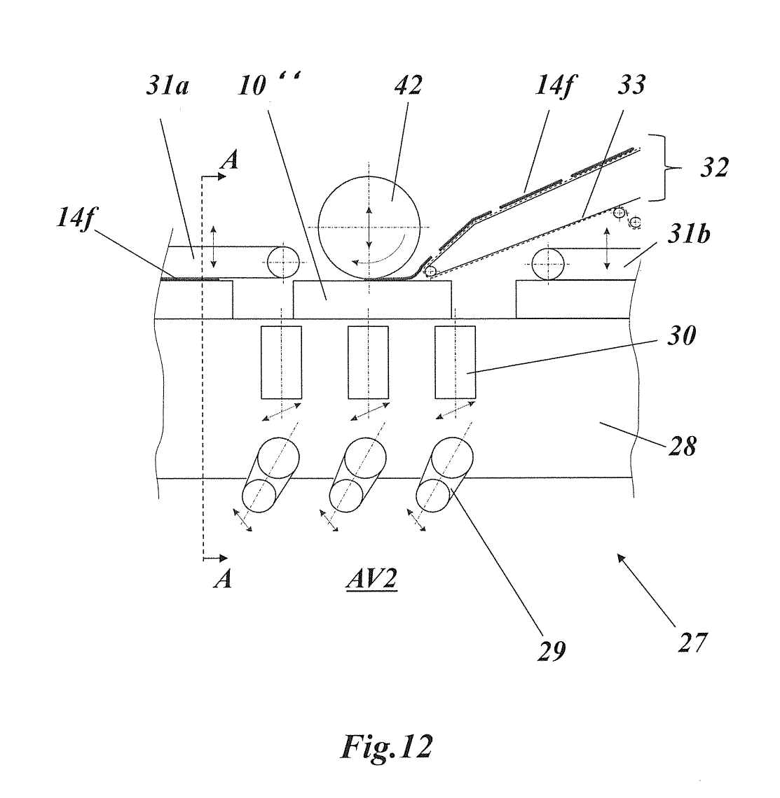

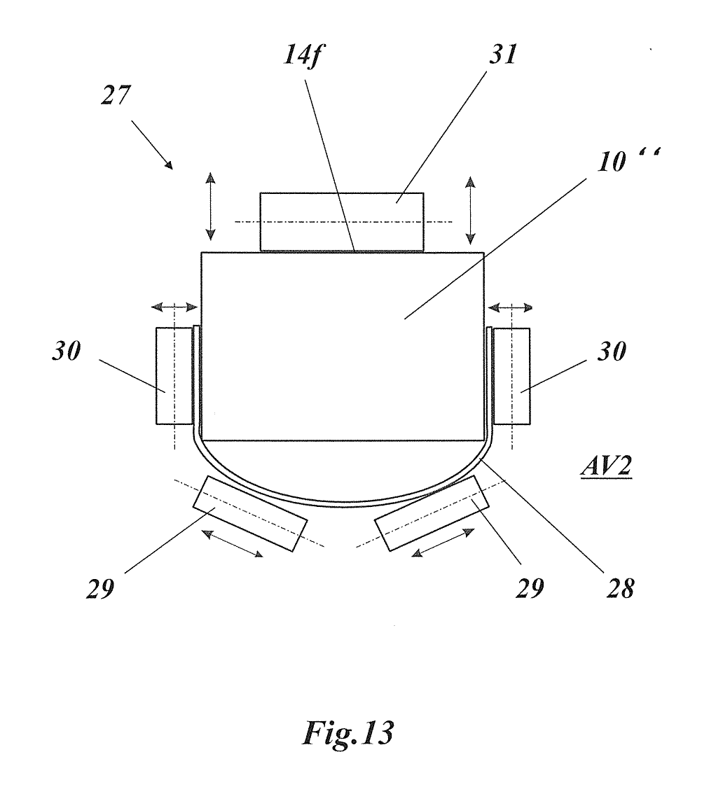

FIG. 12 shows a schematic side view of an application device 27, or AV2, that is particularly suitable for rapid application in the case of simple and repeatedly recurring article shapes. In FIG. 12, the article 10″ has a simple, packet-type packaging in the shape of a rectangular solid. Clearly, other recurring packagings are also conceivable here. A flexible belt 28, which is U-shaped in cross-section and preferably of rubber, is provided for the purpose of conveying the article 10″ to be processed beneath and past an application roller 42. The belt 28 can accommodate the articles 10″ in a holding and positioning manner, some of the articles 10″ that have a predefined location for equipping with the additional information projecting out of the U-shaped belt, as can be seen in FIG. 12 (and FIG. 13). The articles 10″ are held and conveyed by support rollers 29 and pressure rollers 30 that are disposed so as to bear against the bottom and side of the belt 28, on the outside. The support rollers 29 and pressure rollers 30 are each designed so as to be movable in appropriate spatial directions, as illustrated by the double arrows in the figure.

Owing to the mobility of the support rollers 29 and pressure rollers 30, and the flexible design of the belt 28, a self-adjusting channel is formed for the articles 10″, in which the articles 10″ are held and conveyed. The support rollers 29 may also serve to exert a certain counter-pressure on the articles 10″, which may be advantageous in the application of information carriers 14f. The conveying operation may be controlled by means of a control information, the control information being able to be coupled to a result of a previous sensing of the article 10″.

The application device 27 furthermore comprises guide belts 31a, b and a flexible application roller 42, preferably made of foam. The guide belts 31a, b hold the article 10″ at a predefined height and, by a rolling motion, are instrumental in conveying the articles 10″. In addition, the guide belts 31a, b can be moved in the vertical direction, as indicated by double arrows in the figure. As a result of the motion in the vertical direction, the guide belt 31a can press against an information carrier 14f lying at a predefined location on the article 10″. The application roller 42 can likewise be moved in the vertical direction, as illustrated by the double arrow in the application roller 42. Information carriers 14f that are supplied on a carrier belt 33 from an information-carrier feed device 32 can be drawn off the carrier belt 33 by the flexible application roller 42 because of a rolling motion, and applied at a predefined location on the article 10″. The rolling motion of the flexible application roller 42 is indicated by an arcuate arrow within the pressure roller 42. The flexible design of the flexible application roller 42 makes it possible for articles having uneven surfaces, or surfaces other than a standard surface, to be equipped with additional information, without deforming the article 10″ or damaging the packaging of the article 10″.

The information carriers 14f are supplied from the information-carrier feed device 32, the information carriers 14f lying on the carrier belt 33, by means of an adhesive layer, such that they can be drawn off. After the information carriers 14f have been drawn off, the carrier belt 33 continues in the information-carrier feed device 32.

The speeds of the guide belts 31a, b and of the application roller 42 and the belt 28, and the rate of feed of the information carriers 14f by the information-carrier feed device 32 are matched to one another, so as to ensure that the articles 10″ are conveyed in a suitable manner and that the information carriers 14f are applied to the articles 10″ in a reliable manner, at the predefined location. The speeds may be controlled by a control information, the control information being able to be coupled to a result of a sensing of the articles 10″, e.g. an optical sensing of basic information already present on the articles 10″.

FIG. 13 shows a schematic side view of the application device 27, or AV2, along the section line A-A in FIG. 12. In the sectional view shown, the U-shaped flexible belt 28 is visible, with the rollers 29 and 30. Movements of the rollers are illustrated by double arrows, the movements of the rollers not necessarily being limited to the directions shown. In the configuration that is shown in the figure, the lateral pressure rollers 29 press on the lateral faces of the article 10″, which is partly accommodated in the belt 28 and held in place in the belt 28 by the pressure rollers 29. A rolling motion of the pressure rollers 29 enables the articles 10″ to be conveyed. The upper guide belt 31a serves both to convey the article 10″ and to press the information carrier 14f onto the article 10″.

If, in the context of a marketing or advertising action, the information carriers 14, with the additional information for the end buyer, are to be provided in accordance with external information, it is expedient for the application process 15a, b to be combined with external information sources, e.g. databases.

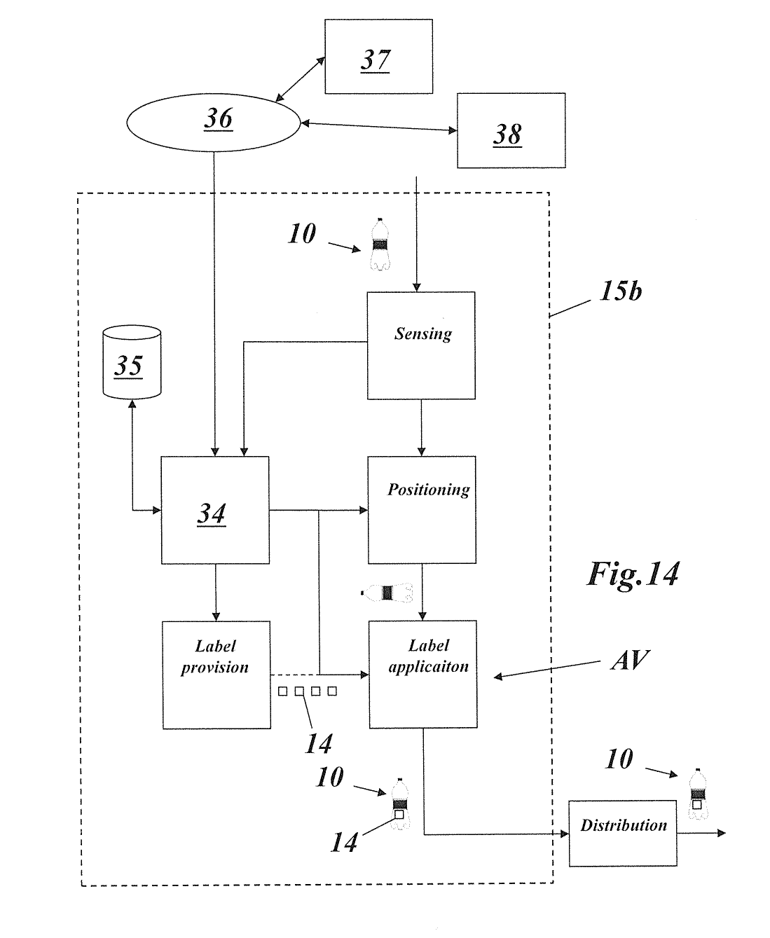

FIG. 14 shows such a schematic representation, in which the article 10 undergoes sensing and positioning in the course of an application process, in order then, in the application step, to be provided with the information carrier (label) 14 by the application device AV.

This operation is controlled by a controller 34, which acts in combination with a local memory 35, receives data, concerning the type and shape of the article 10, from the sensing operation, and control the provision of the labels 14, the positioning of the article 10 and the application of the labels 14. In addition, the controller is connected, via a communication network or network 36, to external databases 37, 38, in which data concerning the ordered article, and concerning the order itself, are stored. Such data may be, for example, the name and address of an end buyer who has ordered the article online, or information concerning particular customer groups, to which a corresponding advertising action is then assigned.

These data go into the controller 34 and influence primarily the provision of the labels 14, but also, if necessary, the positioning of the labels 14 on the article 10.

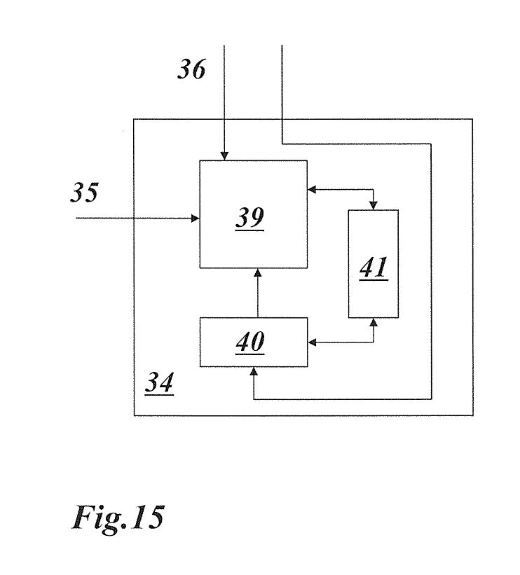

Accommodated within the controller 34, as shown by FIG. 15, there may be a local open-loop/closed-loop control unit 39, which acts in combination with the local memory 35 and receives the external data from the network 36. Connected on the input side of the local open-loop/closed-loop control unit 39 there is a pre-process open-loop/closed-loop controller 40 that processes the information from the sensing step. The local open-loop/closed loop control unit 39 and the pre-process open-loop/closed-loop controller 40 work in combination with an adaptive closed-loop control module 41, such that, overall, a flexible, adaptive application process is provided, cf., for example, FIG. 11. The closed-loop control module 41 may be connected to an operating console, to enable particular closed-loop control steps to be incorporated.

It is claimed:

1. A method for equipping the packaging (11) of an article (10, 10′, 10″), packaged ready for sale, with additional information intended for the end buyer of the article, comprising the following steps:
a. providing the article (10, 10′, 10″) packaged ready for sale;
b. providing an information carrier (14; 14a-f) with the additional information;
c. determining a location on or at the packaging (11), at which the information carrier (14; 14a-f) is to be placed;
d. placing the information carrier (14; 14a-f) at the predetermined location on or at the packaging (11) of the article packaged (10, 10′, 10″) ready for sale, in such a manner that the information carrier (14; 14a-f) remains at this location; and
e. providing the article (10, 10′, 10″), provided with the information carrier (14; 14a-f), for further processing.

2. The method according to claim 1, further comprising:
placing basic information (12; 12a-c) for the end buyer of the article (10, 10′, 10″) on the packaging (11) of the article (10, 10′, 10″) packaged ready for sale, and the location for the additional information (14; 14a-f) is determined, according to the placing of the basic information (12; 12a-c), in step (c).

3. The method according to claim 2, wherein the basic information (12a) is at least partly covered by the application of the additional information (14a).

4. The method according to claim 2, wherein the additional information (14b) together with the basic information (12b) constitutes an information unit.

5. The method according to claim 2, wherein the additional information (14c) is applied entirely separately from the basic information (12c).

6. The method according to claim 1, wherein, before step (d), the article (10, 10′, 10″) packaged ready for sale is positioned in its spatial position with respect to step (d).

7. The method according to claim 6, further comprising:
sensing a type and/or current position of the article before the article (10, 10′, 10″) packaged ready for sale is positioned, and using a result of this sensing to control one or more subsequent method steps.

8. The method according to claim 7, further comprising:
sensing a spatial shape of the article before the article (10, 10′, 10″) packaged ready for sale is positioned, and using a result of this sensing to control one or more subsequent method steps.

9. The method according to claim 1, wherein the article (10, 10′, 10″) packaged ready for sale is produced in a production process, and step (a) follows the production process.

10. The method according to claim 1, wherein the article (10, 10′, 10″) packaged ready for sale is in packs and, in step (a), the article packaged ready for sale (10, 10′, 10″) is singled for further processing.

11. The method according to claim 9, wherein, in step (e), a multiplicity of articles (10, 10′, 10″) packaged ready for sale and provided with the information carrier (14; 14a-f) are grouped together to form a pack.

12. The method according to claim 1, further comprising using externally supplied control information (16) for providing the information carriers (14; 14a-f) provided with the additional information.

13. The method according to claim 12, wherein the externally supplied control information (16) is suitable for individualizing the information carriers (14; 14a-f) provided with the additional information.

14. The method according to claim 12, wherein the externally supplied control information (16) for individualizing the information carriers (14; 14a-f) provided with the additional information is supplied from external databases (37, 38), via a network (36).

15. An apparatus for executing the method according to claim 1, wherein the apparatus comprises a controllable application device (AV, AV1, AV2), and a controller (34) that controls the operation of the controllable application device (AV, AV1, AV2).

16. The apparatus according to claim 15, wherein the controller (34) is designed for the inputting of external control information (16).

17. The apparatus according to claim 16, wherein the controller (34) is connected to external databases (37, 38) via a network (36).

18. The apparatus according to claim 15, wherein the controller (34) is connected to means for sensing the type and/or current position and/or spatial shape of the article.

19. The apparatus according to claim 15, wherein the controllable application device (AV, AV1, AV2) is connected to means for sensing the type and/or current position and/or spatial shape of the article.

20. The apparatus according to claim 15, further comprising means for providing the information carriers, the means for providing the information carriers being connected to the controller (34) and to the controllable application device (AV, AV1, AV2).

21. The apparatus according to claim 15, wherein the controllable application device (AV2) comprises first means (28, 29, 30, 31, 31a, 31b) for taking the article (10″) past second means (32, 33, 42) for applying the information carriers (14f).

22. An information carrier (14; 14a-f) for equipping the packaging (11) of an article (10, 10′, 10″), packaged ready for sale, with additional information intended for the end buyer of the article, in a method according to claim 1, wherein the information carrier (14; 14a-f) can be detached without residue from the article (10, 10′, 10″).

23. The information carrier according to claim 22, wherein the detached information carrier (10, 10′, 10″) can be repositioned on the packaging of the same article or at a different location.

24. The information carrier according to claim 22, wherein the information carrier (14d) is provided with electronic means for storing and/or transmitting the information.

25. The information carrier according to claim 24, wherein the information carrier (14d) comprises an NFC device (18).

26. The information carrier according to claim 25, wherein the information carrier (14d) may be repositioned on an NFC-enabled smartphone (20), in such a manner that the NFC device (18) of the information carrier (14d) can establish near-field communication with the smartphone (20).

27. The information carrier according to claim 24, wherein the information carrier (14d) comprises data for determining a utilization number, preferably a serial number, of the information carrier (14d).
